(19) United States
(12) Patent Application Publication
(10) Pub. No.: US 2016/0296067 A1
(43) Pub. Date: Oct. 13, 2016

(54) POURING ASSISTANCE DEVICE

(71) Applicant: Cynthia LAWS, North Ridgeville, OH (US)

(72) Inventor: Cynthia LAWS, North Ridgeville, OH (US)

(21) Appl. No.: 15/088,310

(22) Filed: Apr. 1, 2016

Related U.S. Application Data
(63) Continuation of application No. 13/362,435, filed on Jan. 31, 2012, now abandoned.
(60) Provisional application No. 61/438,316, filed on Feb. 1, 2011.

(51) Int. Cl. A47J 36/34; A47J 45/06; F16B 47/00; A47J 47/01

(52) U.S. Cl. CPC A47J 36/34; A47J 47/01; A47J 45/06; F16B 47/00

(57) ABSTRACT

A pouring assistance device and method for pouring the contents from a container removably secured to the device. The device includes a base, and a support platform pivotally mounted to the base for supporting the container removably placed on the support platform. One or more tilt handles are mounted to the base for tilting the support platform. A restraining guide attached to the support platform secures the container on the support platform when the support platform is tilted.

### CROSS-REFERENCE TO RELATED APPLICATIONS

This application claims the benefit of U.S. Provisional Patent Application No. 61/438,316 filed on Feb. 1, 2011 and U.S. Nonprovisional Patent Application Ser. No. 13/362,435 filed on Jan. 31, 2012, both of which are incorporated herein by reference.

### TECHNICAL FIELD

The present invention relates generally to a device for assisting in pouring the contents of a bowl. More specifically, the device includes a fixed base, a tiltable bowl platform to support a bowl, and a restraining bar and guide keep the bowl from sliding off the bowl platform as it tilts.

### BACKGROUND

During food preparation, there are many tasks that require pouring the contents of one bowl into another bowl, dish, or pan. When large bowls are filled with liquid or other heavy food contents, such as pasta, it can be difficult to maneuver the bowl while simultaneously using a utensil such as a spatula to remove the bowl contents. Therefore, it is desirable to have a device to assist in pouring the contents of a bowl.

### SUMMARY

According to an embodiment of the present invention, a pouring assistance device for pouring the contents from a container removably secured to the device includes a base, and a support platform pivotally mounted to the base for supporting the container removably placed on the support platform. One or more tilt handles are mounted to the base for tilting the support platform. A restraining guide attached to the support platform secures the container on the support platform when the support platform is tilted.

According to another embodiment of the present invention, a method of pouring contents from a container includes: placing the container on a support platform; securing the container to the support platform; and tilting the support platform to pour the contents from the container.

These and other embodiments are described in greater detail below.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices,” or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front three-dimensional view of a first embodiment of the pouring assistance device, in accordance with the present invention.

FIG. 2 is a front three-dimensional view of the first embodiment of the pouring assistance device, as shown in FIG. 1, in use with a bowl, in accordance with the present invention.

FIG. 3 is a side view of the first embodiment of the pouring assistance device in use with a bowl, as shown in FIG. 2, in a tilted position, in accordance with the present invention.

FIG. 4 is a front three-dimensional view of a second embodiment of the pouring assistance device, in accordance with the present invention.

FIG. 5 is a side view of the second embodiment of the pouring assistance device, as shown in FIG. 4, in use with a bowl, in accordance with the present invention.

FIG. 6 is a front three-dimensional view of a third embodiment of the pouring assistance device, in accordance with the present invention.

FIG. 7 is a front three-dimensional view of a fourth embodiment of the pouring assistance device, in accordance with the present invention.

FIG. 8 is a side view of the fourth embodiment of the pouring assistance device, as shown in FIG. 7, in use with a bowl, in accordance with the present invention.

FIG. 9 is a side view of the fourth embodiment of the pouring assistance device, as shown in FIG. 7, in use with a bowl and with the platform of the pouring assistance device raised, in accordance with the present invention.

FIG. 10 is a side view of the fourth embodiment of the pouring assistance device, as shown in FIG. 7, in use with a bowl with the platform of the pouring assistance device raised and tilted, in accordance with the present invention.

FIG. 11 is a front three-dimensional view of the fourth embodiment of the pouring assistance device, as shown in FIG. 7, in a folded state, in accordance with the present invention.

### DETAILED DESCRIPTION OF ILLUSTRATIVE EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. Generally speaking, it is the relationship between various elements, where they are located, their contrasting compositions, and sometimes their relative sizes that is of significance.

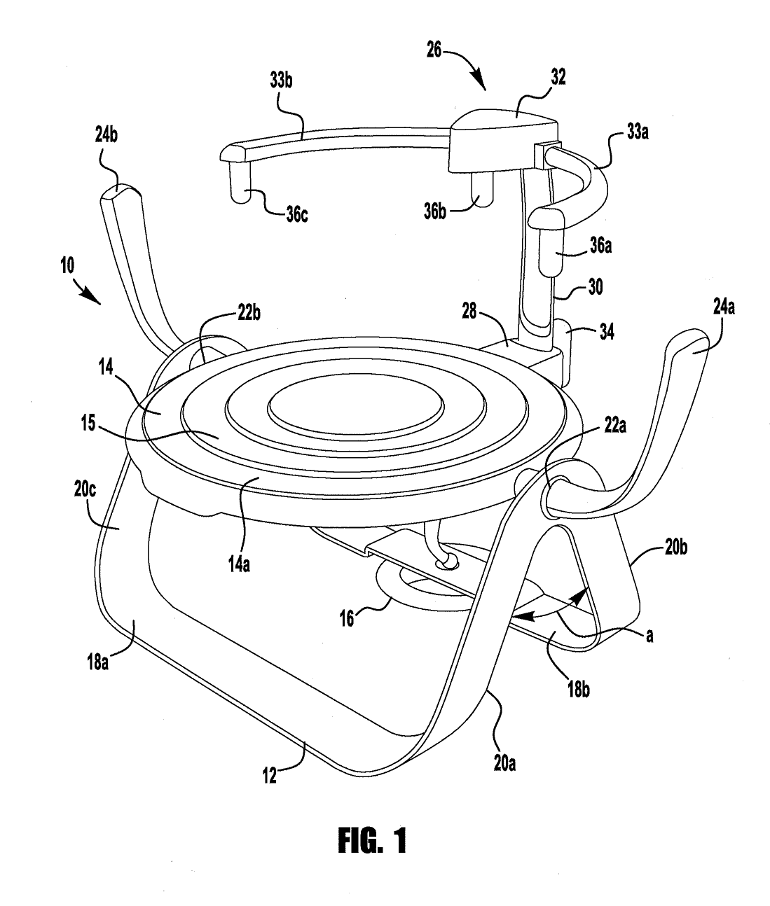

The present invention is directed to a pouring assistance device 10 (hereafter “assistance device”), as shown in FIG. 1. The assistance device 10 is designed to provide the user with the ability to pour or remove food or liquid from a container without having to use both hands to hold the pot or bowl that is being emptied. The advantages of the present invention include the ability to easily and safely dispense contents from a container such as a bowl, pot, Dutch oven, or the like. Embodiments of the assistance device 10 are well-suited for professional chefs, home cooks, and anyone who needs assistance in handling a heavy bowl or pot while dispensing its contents. The term “bowl” is used to refer to any suitable container, and may comprise a bowl, pot, sauce pan, Dutch oven, or the like.

FIG. 1 is a front, three dimensional view of assistance device 10 in accordance with a first embodiment of the present invention. Assistance device 10 comprises a base 12 and tiltable support platform 14. Base 12 may be comprised of a durable material such as stainless steel. The base 12 may have non-skid rubber stoppers or a suction cup 16 to keep the base secured in place on a counter. Base 12 is composed of two elongated, spaced supports 18a and 18b which are connected to each other by upstanding legs 20a, 20b, 20c, and 20d . Legs 20a-20d are joined at one end to the supports 18a, 18b and at the other end to each other. These legs 20a and 20b and 20c and 20d form an angle a to one another in the range of between about 30° and 60° to each other. The base 12 can be attached to the edge of a countertop or table by a C-clamp.

A tiltable support platform 14 is pivotally secured to the base 12 at pivot points 22a and 22b where the legs 20a, 20b and 20c, 20d intersect. Support platform 14 may have a non-slip and heat resistant material 15 such as silicone on the surface 14a to prevent slipping during the dispensing of contents of a bowl. Further, support platform 14 can, but need not be, circular in shape.

There are two tilt handles 24a and 24b that protrude from base 12, each extending through opposite pivot points 22a and 22b, respectively. Handles 24a and 24b are designed to tilt the platform 14 and allow for easy pouring and manipulation of the bowl by the user. Handles 24a and 24b each have a lock out feature to secure the platform in place.

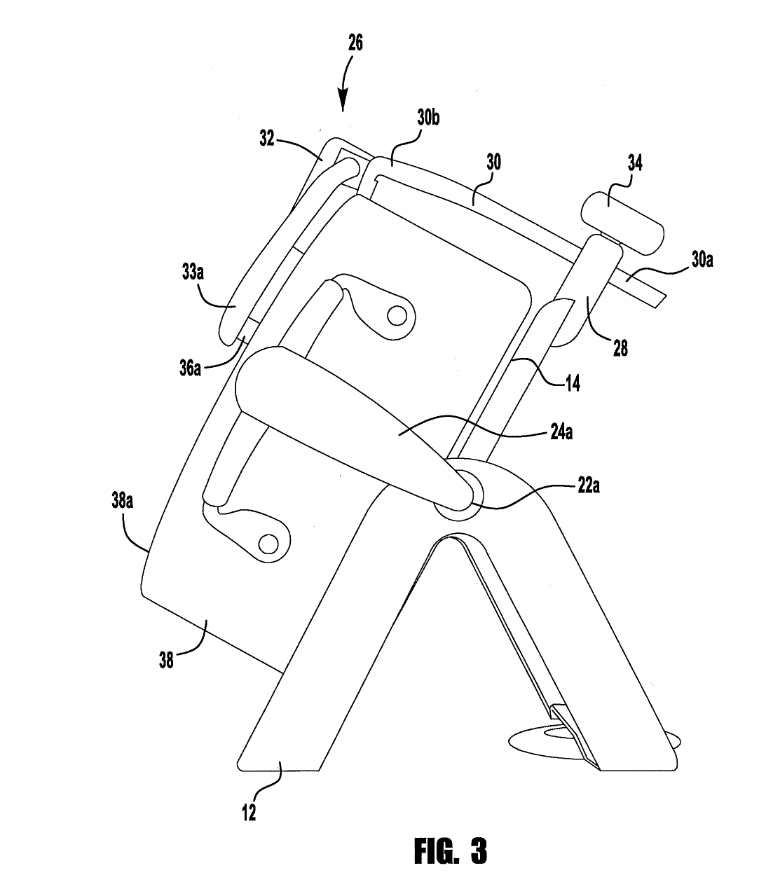

A stand 28 is secured to and projects out from the tiltable support platform 14 as best shown in FIG. 3. A restraining guide 26 is attached to the stand 28 projecting outward from the rear portion of tiltable support platform 14. Restraining guide 26 serves to keep a bowl on the tiltable support platform 14. Restraining guide 26 consists of an adjustment rail 30, which is secured at one end 30a in a channel through stand 28 via a securing mechanism such as a bolt connected to a knob 34. A pair of arms 33a and 33b are attached to a bracket 32 which is secured to the end 30b of adjustment rail 30. Arms 33a and 33b may be attached to a bracket 32 so that the free ends can be moved towards each other against the bias of a spring device.

Adjustment rail 30 allows restraining guide 26 to be adjustable in a vertical direction.

Arms 33a and 33b can be positioned in the vertical direction with respect to platform 14 by moving the bracket 32 on rail 30 and adjusting rail 30 to the appropriate height to accommodate a particular bowl. This adjustment allows the assistance device 10 to accommodate bowls and containers of various heights. Arms 33a and 33b are not only adjustable in a vertical direction with respect to platform 14 in order to accommodate various sizes of bowls but the free ends can be moved towards each other against the bias of a spring device to accommodate various types of pots or bowls with different diameters. Arms 33a and 33b, and bracket 32 are equipped with posts 36a, 36b, and 36c extending downwards toward the platform 14, are typically constructed of soft material such as silicone. The posts 36a, 36b, and 36c are located so as to be disposed within a pot 38 and against the interior surface as discussed hereinafter.

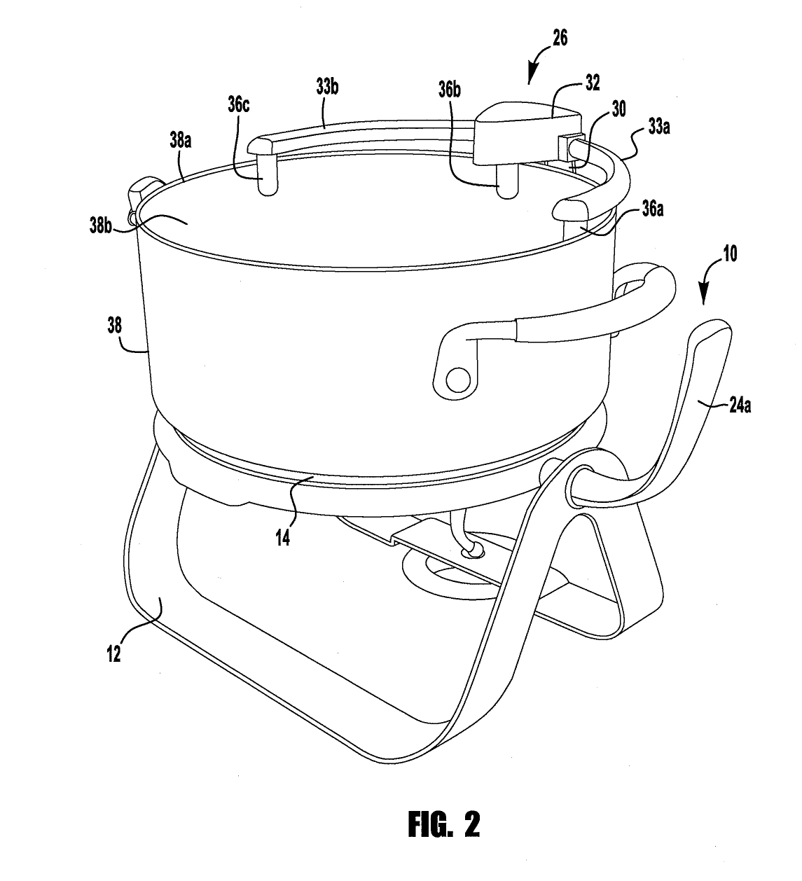

FIG. 2 illustrates a front, three dimensional view of assistance device 10 showing a bowl 38 on the support platform 14. Restraining guide 26 may be adjusted such that the arms 33a and 33b are above the top edge 38a of the bowl, and the posts 36a, 36b, and 36c project down into the bowl from the top edge and engage the inner surface 38b to secure the bowl upon the support platform 14 during dispensing. Because of the adjustability of both the rail 30 and the arms 33a and 33b, a wide array of bowl sizes may be accommodated for use with the assistance device 10.

FIG. 3 is a side view of assistance device 10, showing a bowl 38 on the support platform 14, with support platform in a tilted orientation, or “dispensing position.” Bowl 38 is tilted at an angle sufficient to allow the pouring of the contents from the bowl. Tilt handles 24a and 24b are provided to allow the user to manipulate and tilt the bowl 38 into its dispensing position without requiring that the bowl itself is touched, since the contents therein might be hot. To transition from a “flat position” as shown in FIGS. 1 and 2, to a dispensing position, the user manipulates tilt handles 24a and 24b, which in turn causes tiltable support platform 14 to pivot at pivot points 22a and 22b and to raise the back end of the support platform, as shown in FIG. 3. With support platform 14 tilted, the contents of bowl 38 may be easily removed.

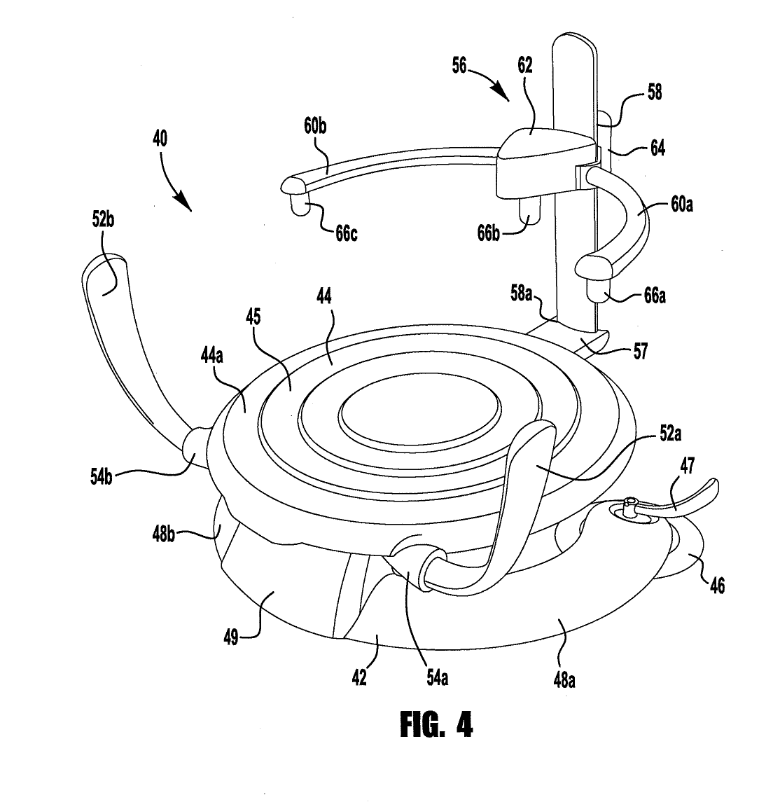

FIG. 4 is a front view of a second embodiment of the pouring assistance device 40 which operates in a manner as described with pouring assistance device 10 in FIG. 1. Assistance device 40 comprises a base 42 and tiltable support platform 44. Base 42 may be comprised of a durable material such as stainless steel. The base 42 may have non-skid rubber stoppers or a suction cup 46 to stay in place on a counter. Suction cup 46 has a lever 47 to tighten the suction cup to the counter and then subsequently release it. Base 42 is composed of two elongated spaced supports 48a and 48b which are connected to each other by a support connector 49.

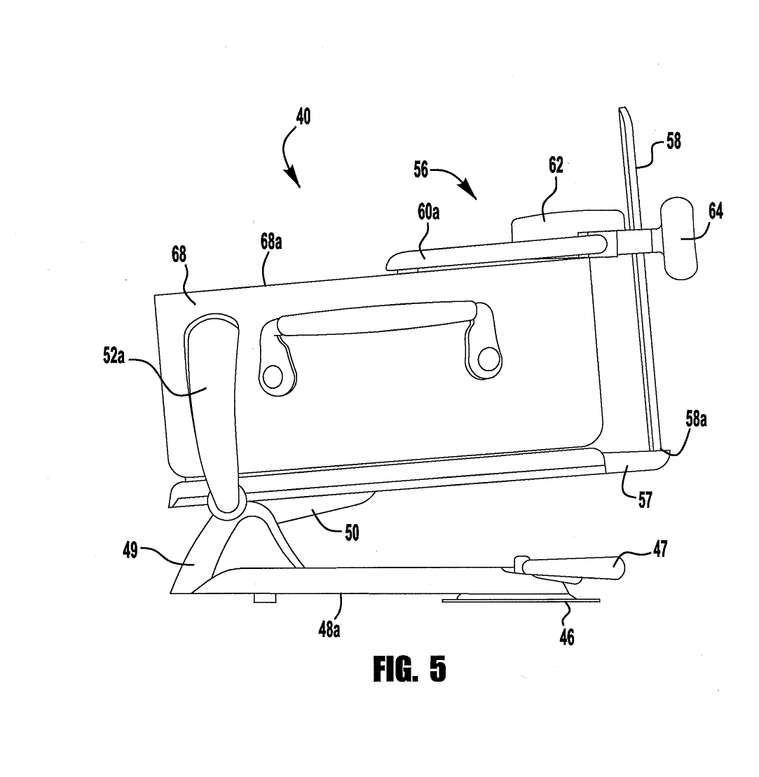

A tiltable support platform 44 is pivotally secured to the base 42 on a stand 50 which is mounted to the support connector 49, as seen in FIG. 5. Support platform 44 may have a non-slip and heat resistant material 45 such as silicone on the surface 44a to prevent slipping during the dispensing of contents of a bowl. Note that for the purposes of this disclosure, the term “bowl” is used to refer to any suitable container, and may comprise a bowl, pot, sauce pan, Dutch oven, or the like. Further, support platform 44 is typically circular in shape.

There are two tilt handles 52a and 52b that protrude from support platform 44, each affixed at an appropriate location within mounts 54a and 54b. Handles 52a and 52b are designed to tilt the platform 44 and allow for easy pouring and manipulation of the bowl by the user. Handles 52a and 52b each have a lock out feature to secure the platform in place.

A stand 57 is secured to and projects out from the tiltable support platform 44 as best shown in FIG. 5. A restraining guide 56 is attached to the stand 57 projecting outward from the rear portion of tiltable support platform 44. Restraining guide 56 serves to keep a bowl on the tiltable support platform 44. Restraining guide 56 includes an adjustment rail 58, which is secured at one end 58a to stand 57. A pair of arms 60a and 60b are attached to a bracket 62 having a channel therethrough which receives adjustment rail 58 therein so that the bracket 62 can be moved and secured to adjustment rail 58 by a knob 64 which forces a bolt mechanism against the rail 58 to keep the bracket in a desired location. Arms 60a and 60b may be attached to a bracket 62 so that the free ends can be moved towards each other against the bias of a spring device. Knob 64 allows the user to adjust bracket 62 along rail 58 to the appropriate height to accommodate a particular bowl. The knob 64 is loosened by the user and the bracket 62 is adjusted vertically by the user, until a desired height is reached. Then, the knob 64 is tightened to secure the restraining guide 56 at a desired location. This allows the assistance device 40 to accommodate bowls and containers of various heights.

Arms 60a and 60b are not only adjustable in a vertical direction with respect to platform 44 in order to accommodate various sizes of bowls but the free ends can be moved towards each other against the bias of a spring device to accommodate various types of pots or bowls with different diameters. Arms 60a and 60b, and bracket 62 are equipped with posts 66a, 66b, and 66c extending downwards toward the platform 44, are typically constructed of soft material such as silicone. The posts 66a, 66b, and 66c are located so as to be disposed within a pot 68 and against the interior surface as discussed hereinafter.

FIG. 5 illustrates a side view of assistance device 40 showing a bowl 68 on the support platform 44. Restraining guide 56 may be adjusted such that the arms 60a and 60b are above the bowl top 68a, and the posts 66a, 66b, and 66c engage the bowl top 68a to secure it upon the support platform 44 during dispensing. Because of the adjustable natures of both the rail 58 and the arms 60a and 60b, a wide array of bowl sizes may be accommodated for use with the assistance device 40. When dispensing the contents of the bowl 68, the operation is identical to the operation described in regards to FIG. 3. The only difference is the pivot point is at the support connector 49. The user simply manipulates and tilts the bowl 68 into its dispensing position utilizing tilt handles 52a and 52b, causing tiltable support platform 44 to pivot at the support connector 49, and raising the back end of the support platform. With support platform 44 tilted, contents of bowl 68 may be easily removed or spilled out.

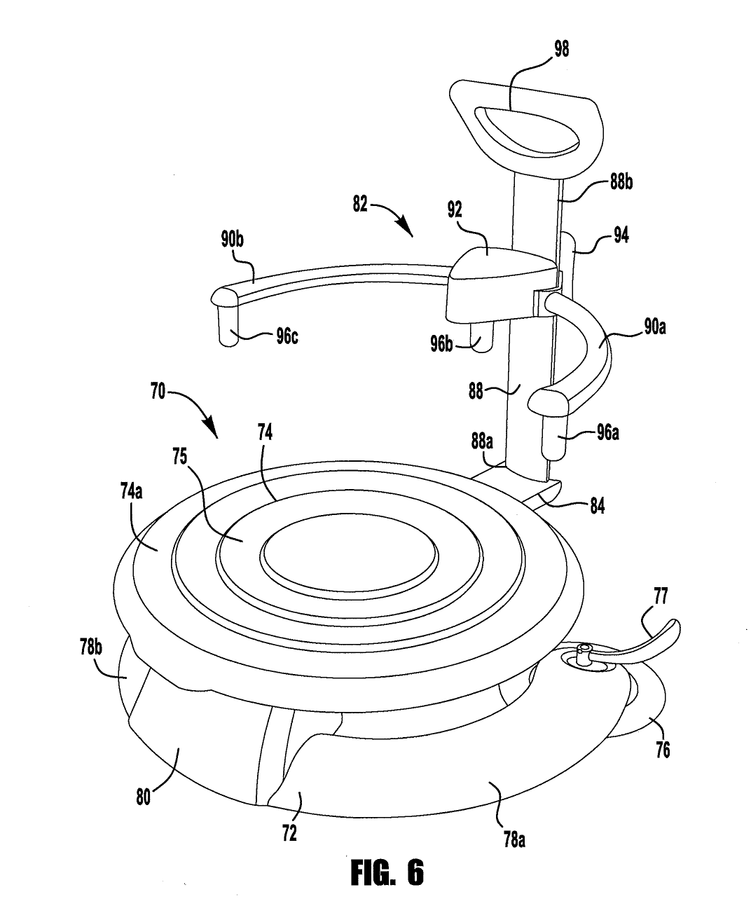

FIG. 6 is a front three dimensional view of a third embodiment of the pouring assistance device 70. Assistance device 70 comprises a base 72 and tiltable support platform 74. Base 72 may be comprised of a durable material such as stainless steel. The base 72 may have non-skid rubber stoppers or a suction cup 76 to stay in place on a counter. Suction cup 76 has a lever 77 to tighten the suction cup to the counter and then subsequently release it. Base 72 is composed of two elongated spaced supports 78a and 78b which are connected to each other at support connector 80.

The tiltable support platform 74 is pivotally secured to the base 72 on a stand which is mounted to the support connector 80 (not seen). Support platform 74 may have a non-slip and heat resistant material 75 such as silicone on the surface 74a to prevent slipping during the dispensing of contents of a bowl. Note that for the purposes of this disclosure, the term “bowl” is used to refer to any suitable container, and may comprise a bowl, pot, sauce pan, Dutch oven, or the like. Further, support platform 74 is typically circular in shape.

A stand 84 is secured to and projects out from the tiltable support platform 74 in the manner as best shown in FIG. 5. A restraining guide 82 is attached to the stand 84 projecting outward from the rear portion of tiltable support platform 74. Restraining guide 82 serves to keep a bowl on the tiltable support platform 74. Restraining guide 82 consists of an adjustment rail 88, which is secured at one end 88a to stand 84.

A pair of arms 90a and 90b are attached to a bracket 92 having an open channel therethrough which receives adjustment rail 88 therein so that the bracket 92 can be moved and secured to adjustment rail 88 by a knob 94 which forces a bolt mechanism against the rail 88 to keep the bracket in a desired location. Arms 90a and 90b may be attached to a bracket 92 so that the free ends can be moved towards each other against the bias of a spring device. Knob 94 allows the user to adjust bracket 92 along rail 88 to the appropriate height to accommodate a particular bowl. The knob 94 is loosened by the user and the bracket 92 is adjusted vertically by the user, until a desired height is reached. Then, the knob 94 is tightened to secure the restraining guide 82 at a desired location. This allows the assistance device 40 to accommodate bowls and containers of various heights.

Arms 90a and 90b are not only adjustable in a vertical direction with respect to platform 74 in order to accommodate various sizes of bowls but the free ends can be moved towards each other against the bias of a spring device to accommodate various types of pots or bowls with different diameters. Arms 90a and 90b, and bracket 92 are equipped with posts 96a, 96b, and 96c extending downwards toward the platform 74, are typically constructed of soft material such as silicone. The posts 96a, 96b, and 96c are located so as to be disposed within a pot and against the interior surface as discussed hereinafter.

Located atop rail 88 at a second end 88b is handle 98. In operation, when dispensing the contents of the bowl, the operation is very similar to the operation described in regards to FIG. 5. The only difference is that the user simply manipulates and tilts the bowl into its dispensing position utilizing handle 98 to cause tiltable support platform 74 to pivot at support 80, and raising the back end of the support platform. With support platform 74 tilted, the contents of the bowl may be easily removed.

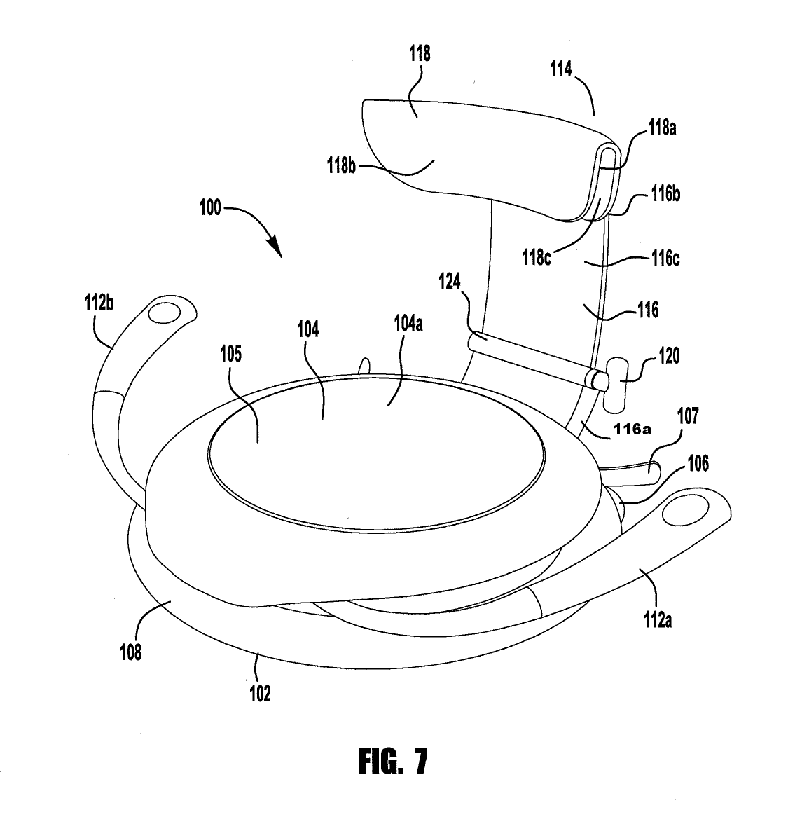

FIG. 7 is a front view of a fourth embodiment of the pouring assistance device 100.

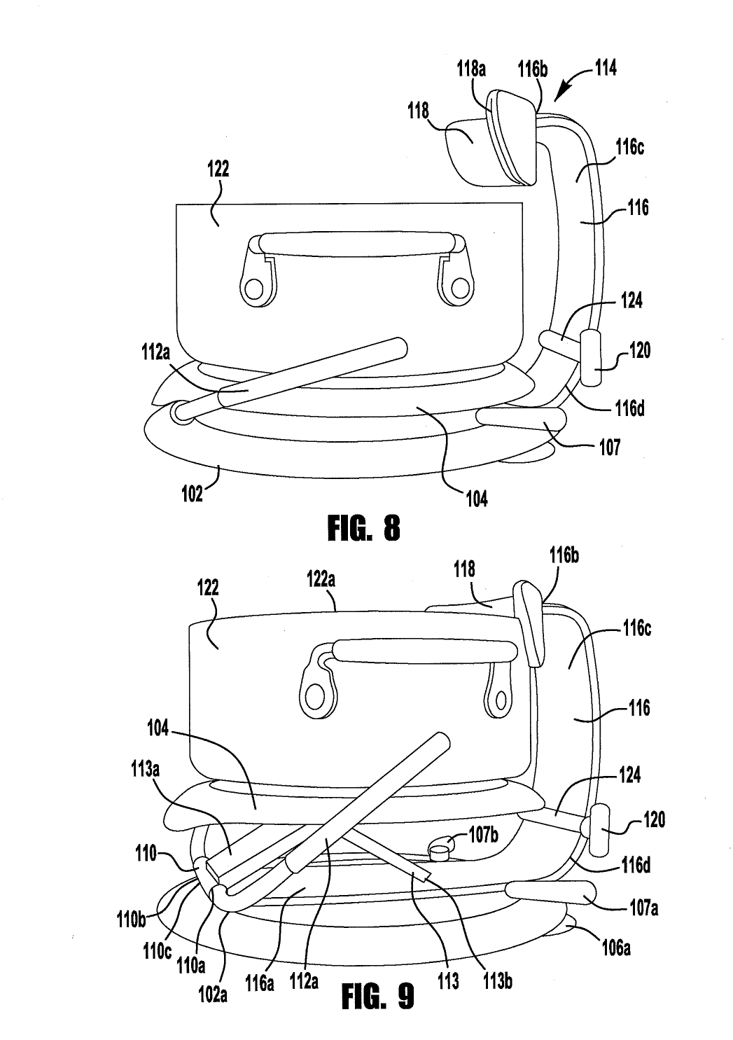

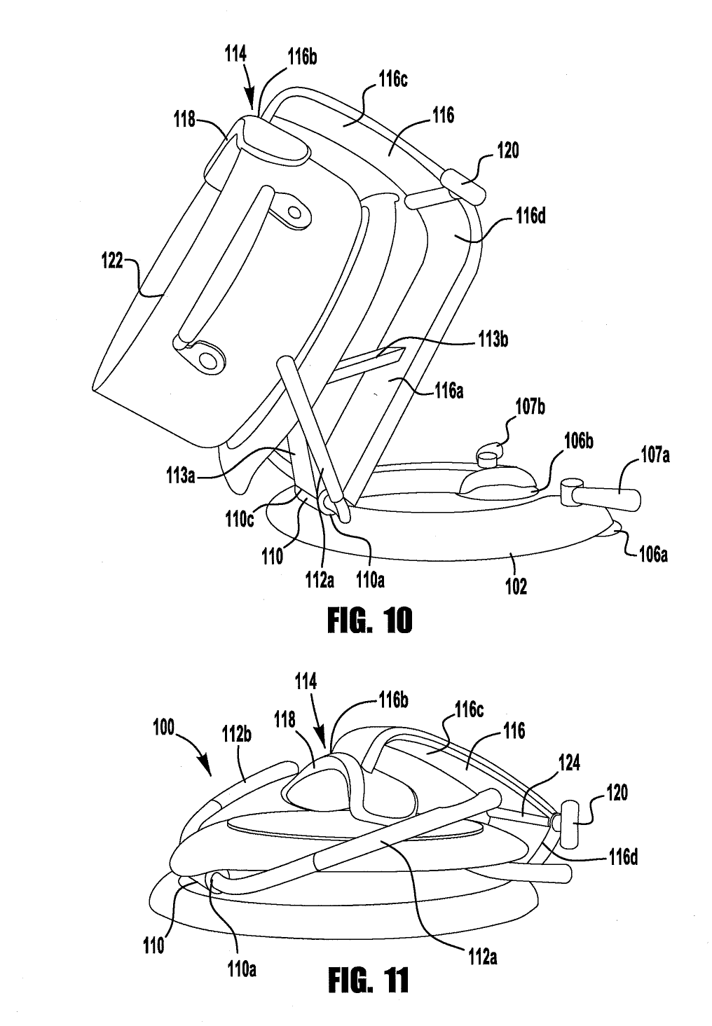

Assistance device 100 comprises a base 102 and tiltable support platform 104. Base 102 may be comprised of a durable material such as stainless steel. The base 102 may have non-skid rubber stoppers or suction cups 106a and 106b to stay in place on a counter, as seen in FIG. 10. Suction cups 106a and 106b have levers 107a and 107b, respectively, to tighten the suction cup to the counter and then subsequently release it. Attached to base 102 at rim 102a, as seen in FIG. 9, is a pivoting joint element 110. Attached to joint element 110 at a first and second end, 110a and 110b, are lift lever arms 112a and 112b.

A tiltable support platform 104 is pivotally secured to the joint element 110 at its central location 110c on a restraining guide 113 having two sections 113a and 113b which are disposed at an angle to each other so that where they meet, they are pivotably secured to the underside of platform 104 and their ends are connected to joint element 110 and the elongated section 116a of an adjustment rail 116. When the platform 104 is collapsed against the elongated section 116a, the two sections 113a and 113b of restraining guide 113 are against the horizontal section 116a. When the lift lever arms 112a and 112b are moved from the position shown in FIG. 8 to the position shown in FIG. 9, the pivoted end of the two sections 113a and 113b of restraining guide 113 rises up so that the sections 113a and 113b form an angle with each other to stabilize the platform 104 in the position spaced above the horizontal section 116a, as shown in FIG. 9.

The adjustment rail 116 includes the elongated section 116a having one end connected to the joint element 110 and the other end to a locking hinge 124. An upper vertical portion 116c of rail 116 is mounted locking hinge 124 and extends upward from the platform 104. A restraining guide 114 is attached to the upper end 116b of the vertical portion 116c. The restraining guide 114 consists of a cupped shaped section 118, which can be constructed of silicone, and which is secured to the upper end 116b of the adjustment rail 116. Cupped shaped section 118 has a back wall 118a which is attached at one end to a front wall 118b so as to form a slot 118c therebetween which opens downward to accommodate a bowl during dispensing, as described below.

A knob 120 is mounted to locking hinge 124 to loosen and tighten the hinge and thereby control the location of the vertical upper portion 116c with respect to the elongated section 116a. Support platform 104 may have a non-slip and heat resistant material 105 such as silicone on the surface 104a to prevent slipping during the dispensing of contents of a bowl. Note that for the purposes of this disclosure, the term “bowl” is used to refer to any suitable container, and may comprise a bowl, pot, sauce pan, Dutch oven, or the like. Further, support platform 104 is typically circular in shape.

FIG. 8 illustrates a side view of assistance device 100 showing a bowl 122 on the support platform 104 but spaced below and out of contact with the cupped shaped section 118.

FIG. 9 illustrates the bowl 122 engaged within the slot 118c of the cupped shaped section 118. This is accomplished by raising lever arms 112a and 112b which causes the pivoted end of the two sections 113a and 113b of restraining guide 113 to rise up so that the sections 113a and 113b form an angle with each other to stabilize the platform 104 in the position spaced above the horizontal section 116a, as shown in FIG. 9. Restraining guide 114 may be adjusted such that the upper edge 122a of bowl 122 moves into the slot 118c of cup shaped section 118 to secure it upon the support platform 104 during dispensing. Because of the adjustable nature of the rail 116, a wide array of bowl sizes may be accommodated for use with the assistance device 100.

When dispensing the contents of the bowl 122, as shown in FIG. 10, the user simply manipulates and tilts the bowl 122 into its dispensing position utilizing lever arms 112a and 112b, after the lever arms have already raised the support platform 104. This causes tiltable support platform 104 to pivot at joint element 110, and raising the back end of the support platform, as seen in FIG. 10. With support platform 104 tilted, contents of bowl 122 may be easily removed.

FIG. 11 shows a front view of the assistance device 100 folded after usage. The support platform 104 is at its lowered height. The upper vertical portion 116c of rail 116 folds down at hinge 124 for storage purposes.

It is within the terms of the invention to include at least one pouring attachment along with any of the above described embodiments of the assistance device. These attachments may include, but are not limited to, a funnel and/or a strainer and have holes therethrough so that when placed on the top edge of the pot, they can be held in place by the posts 36a, 36c, 66a, 66c, and 96a, 96c. These attachments can be used to help guide the liquid contents of bowl into another container bowl. When pouring attachment comprises a strainer, the guiding attachment also serves to help keep solid contents, such as pasta, inside the bowl, while allowing liquid to escape from the bowl.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A pouring assistance device for pouring contents from a container removably secured to the device, comprising:
a base;
a support platform pivotable relative to the base, at least a portion of the support platform underlying the container;
at least one lift lever arm mounted to the base for tilting the support platform; and
a restraining guide adapted to secure the container on the support platform at least when the support platform is tilted, the restraining guide being movable with the support platform.

2. The pouring assistance device of claim 1, the base has a joint element defining at least one pivot hole through which a portion of the at least one lift lever arm extends, the joint element being rotatable with the at least one lift lever arm, and the support platform is attached to the joint element and rotatable therewith.

3. The pouring assistance device of claim 2, the restraining guide is attached to the joint element.

4. The pouring assistance device of claim 1, further comprising:
an adjustment rail, the restraining guide is supported on the adjustment rail;
a joint element rotatably supported on the base;
a first section attached to the joint element and rotatable therewith; and
a second section pivotally coupled with the first section, at least one of the first section and second section engage the support platform to at least tilt the platform relative to the base, and at least one of the first section and the second section engaging the adjustment rail.

5. The pouring assistance device of claim 4, further comprising:
a locking hinge of the adjustment rail;
an elongated section of the adjustment rail having one end connected to the joint element and the other end to the locking hinge; and
an upper vertical portion of the adjustment rail, the upper vertical portion mounted to the locking hinge and extending upward relative to the platform,
the restraining guide includes a cupped shaped section secured to an end of the upper vertical portion, the cupped section configured to engage the container.

6. The pouring assistance device of claim 5, at least a portion of the restraining guide is movable along the upper vertical portion toward or away from the support platform.

7. The pouring assistance device of claim 5, further comprising:
a back wall of the cupped shaped section; and
a front wall of the cup shaped section, the back wall and the front wall defining a slot opening toward the support platform, the slot configured to receive an edge of the container.

8. The pouring assistance device of claim 5, the at least one lift lever arm mounted to an end of the joint element for moving the first section and the second section at their pivot causing of the restraining guide to rise up so that the first section and the second section form an angle stabilizing the support platform in a position spaced above the elongated section of the adjustment rail.

9. The pouring assistance device of claim 1, at least a portion of the support platform being substantially disc shaped.

10. The pouring assistance device of claim 1, further comprising one or more securing components that prevents movement of the base with respect to a surface supporting the base.

11. The pouring assistance device of claim 10, the one or more securing components include a suction cup.

12. A method of pouring contents from a container, comprising:
placing the container on a pouring assistance device including a support platform;
securing the container to the support platform using at least a restraining guide of the pouring assistance device; and
tilting the support platform and the restraining guide to pour the contents from the container.

13. The method of claim 13, further comprising supporting the support platform above a base, tilting of the support platform is performed relative to the base.

14. The method of claim 13, the restraining guide including a cupped shaped section coupled with an upper vertical portion, the cupped section configured to engage the container.

15. The method of claim 14, further comprising:
raising the support platform with at least one lift lever arm to position the container for engagement by the cupped shaped section; and
continuing to raise the support platform to tilt the support platform and container thereon.

16. The method of claim 15, tilting the support platform relative to the base of the pouring assistance device is accomplished using at least one lift lever arm attached to the support platform and pivotally mounted to the base.

17. The method of claim 12, further comprising supporting the restraining guide on an adjustment rail coupled with the support platform.

18. The method of claim 17, further comprising:
adjusting an angular position of the restraining guide with the adjustment rail, the adjustment rail including an elongated section mounted to the support platform, an upper vertical portion extending upward relative to the support platform;
pivoting the upper vertical portion relative to the elongated section; and
selectively securing the position of the upper vertical portion relative to the elongated section with a locking element.

19. The method of claim 12, further comprising securing a base of the pouring assistance device using one or more securing components.

20. The method of claim 19, the one or more securing components include a suction cup.
